(19) United States
(12) Patent Application Publication
(10) Pub. No.: US 2016/0344173 A1
(43) Pub. Date: Nov. 24, 2016

(54) STRUCTURAL INSERT AND METHOD OF USE

(71) Applicant: Daren P Hoeffner, Norcross, GA (US)

(72) Inventor: Daren P Hoeffner, Norcross, GA (US)

(21) Appl. No.: 14/719,548

(22) Filed: May 22, 2015

(51) Int. Cl. H02G 3/22; E04C 2/52

(52) U.S. Cl. CPC H02G 3/22; E04C 2/521

(57) ABSTRACT

Inserts to be placed within walling materials and methods of using the inserts are described. The inserts have protrusions and grips that secure the inserts to the walling materials. Moreover, the inserts have central cavities that allow for cables and like materials to pass through the inserts while the inserts are secured to the walling materials.

### FIELD

This application relates to construction materials, and more particularly to structural inserts.

### BACKGROUND

Various inserts are implemented into structures, such as walls, to increase the strength in which items may be mounted to the walls. Other inserts are implemented through and within walls to form stable passageways for materials, such as cables, to be passed through the walls. However, these inserts often require meticulous and slow installation in order to prevent damage to the insert, the wall, and/or the materials passed through the wall.

SUMMARY

This disclosure provides an insert implementable within a wall to allow for passage of materials through the wall, and a method of using the insert. An aspect of this disclosure relates to an insert with an elongated body. The insert has a protrusion that outwardly extends from an axis of the elongated body near a first end of the elongated body. The insert also has grips that outwardly extend from the axis near a second end of the elongated body. The protrusion may have a circular cross-section. Moreover, the protrusion may radially extend from the axis, which extends through a central cavity of the elongated body from the first end to the second end thereof. Each of the grips may be coextensive with the other grips and each of the grips may radially extend from the axis of the elongated body. Furthermore, each of the grips may have a surface parallel to the protrusion and another surface angularly extending inward toward the second end of the elongated body.

Another aspect of this disclosure relates to an insert with a tubular body. The tubular body has a protrusion radially extending therefrom near a first end thereof. Moreover, two or more grips radially extend from the tubular body near or at a second end of the tubular body. The tubular body may be elongate from the first end to the second end and, further, may have an axis that extends between the first and second ends. One of the grips of the two or more grips may abut the second end of the tubular body. Additionally, each of the two or more grips may have a surface that radially extends from the tubular body parallel to the protrusion, and the surface of each of the grips may have a circumferential edge, which are edges of the grips farthest away from the tubular body.

A further aspect of this disclosure relates to a method of using an insert. The method includes drilling a hole through walling material and placing an insert through the walling material until a protrusion of the insert abuts the walling material and grips of the insert secure the insert to the walling material. The method may further include placing cable or some like material through the insert, maneuvering the walling material to a desired location, and/or securing the walling material.

### BRIEF DESCRIPTION OF THE DRAWINGS

Specific embodiments of this disclosure will become apparent and its construction and operation better understood, from the following detailed description when read in conjunction with the accompanying drawings, in which:

FIG. 1A illustrates a cross-sectional view of an insert according to this disclosure;

FIG. 1B illustrates a cross-sectional view of the insert according to this disclosure;

FIG. 1C illustrates another example of the insert according this disclosure; and

FIG. 2 is a flow chart illustrating a method of using an insert according to this disclosure.

### DETAILED DESCRIPTION

Detailed aspects of this disclosure relating to devices and methods are disclosed herein. However, it is to be understood that the disclosed aspects are merely illustrative of the devices and methods, which may be embodied in various forms. Therefore, specific functional details disclosed herein are not to be interpreted as limiting, but merely as a basis for the claims and as a representative basis for enabling one skilled in the art to employ this disclosure.

This disclosure provides an insert implementable within a wall to allow for passage of materials through the wall. In an implementation, the insert allows passage of cables through drywall. The insert as described herein may be implemented within the wall prior to, during, or after construction of the wall. This is beneficial because it allows cables and like materials to be passed through walls at various times while maintaining a stable passageway that protects the cables and like materials from being damaged during construction of the wall.

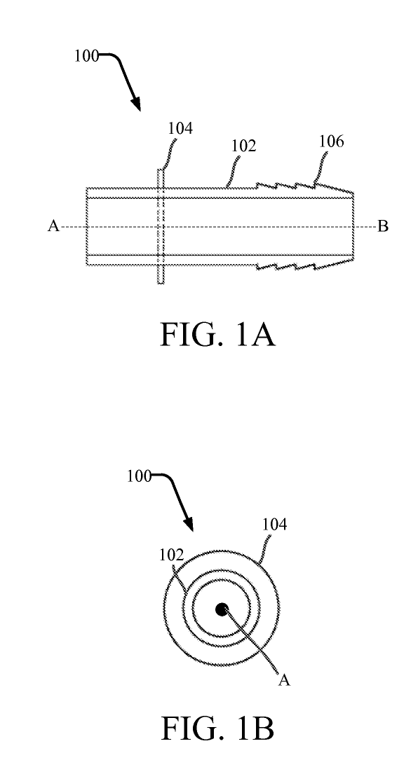

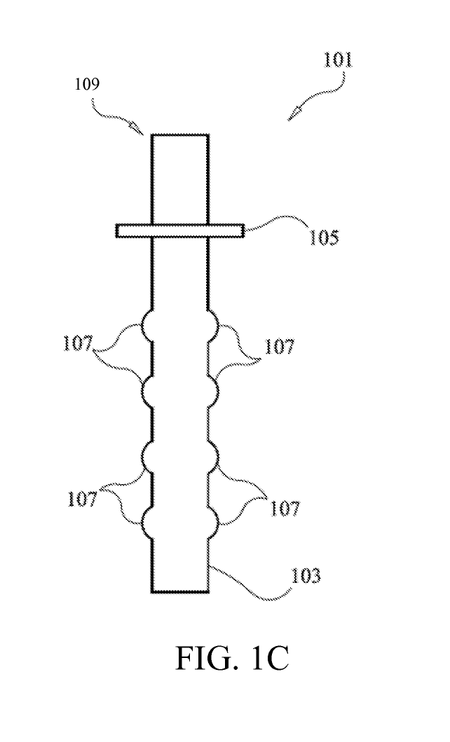

FIGS. 1A and 1B illustrate an insert 100 according to this disclosure. The insert 100 has a tubular or elongate body 102 having an axis (illustrated as dashed line A-B) that runs through the body 102 of the insert 100. The axis is centrally located along a cross-section of the body 102. As illustrated, the body 102 has a circular cross-section. However, the body 102 can have other cross-sections without departing from the scope of this disclosure. For example, a non-limiting list of potential cross-sections includes triangular, ovular, and rectangular. The insert may be constructed from typical construction materials, e.g., steel or plastic.

A protrusion 104 is located on and extends from the body 102. The protrusion 104 may abut a wall when the insert 100 is implemented within the wall, thereby preventing over insertion of the insert 100 within the wall. As illustrated, the protrusion 104 has a circular cross-section and radially extends from the body 102. However, the protrusion 104 can have other cross-sections. Furthermore, the protrusion 104 may have a cross-section identical to, similar to, or different from that of the body 102 without departing from the spirit and scope of this disclosure. The protrusion 104 may be implemented at any location along the body 102 that allows the insert 100 to be secured against a wall. For example, the protrusion 104 may be centrally located on the body 102 or the protrusion 104 may be off-centrally located on the body 102, i.e., toward an end of the body 102.

Grips 106 are also located on and extend from the body 102. The grips 106 prevent the insert 100 from being easily removed from a wall after the insert 100 is implemented within the wall. As illustrated, the grips 106 have circular cross-sections and radially extend from the body 102. However, one skilled in the art should appreciate the grips 106 having other cross-sections. Furthermore, the grips 106 may have cross-sections identical to, similar to, or different from that of the body 102 and/or the protrusion 104 without departing from the spirit and scope of this disclosure. The grips 106 may be implemented at any location along the body 102 that allows the grips 106 to prevent the insert 100 from being easily removed from a wall. For example, the grips 106 may be centrally located on the body 102 or the grips 106 may be off-centrally located on the body 102, i.e., toward an end of the body 102. Moreover, none of the grips 106, some of the grips 106, or all of the grips 106 may have equal cross-sections.

In an implementation, when the insert 100 is implemented within a wall, a surface of the protrusion 104 closest to the grips 106 and a surface of the grips 106 closest to the protrusion 104 each touch respective surfaces of the wall. However, one skilled in the art should appreciate the protrusion 104 and grips 106 to be configured along the body 102 in a way that results in either the surface of the protrusion 104 closest to the grips 106, a surface of the grips 106 closest to the protrusion 104, or neither the surface of the protrusion 104 closest to the grips 106 or a surface of the grips 106 closest to the protrusion 104 touching respective surfaces of the wall. Furthermore, according to various implementations, neither the protrusion 104 nor the grips 106 are located at ends of the body 102, either the protrusion 104 or the grips 106 are located at an end of the body 102, or both the protrusion 104 and the grips 106 are located at respective ends of the body 102.

FIG. 1C illustrates another exemplary insert 101 according to this disclosure. The insert 101 has a tubular or elongate body 103. The body 103 can have a circular cross-section. A protrusion 105 is located on and extends from the body 103. The distance from the protrusion 105 to the end 109 should be about the depth of typical drywall or walling material (e.g., about ¼ inch, ⅜ inch, ½ inch, ¾ inch, or the like). For example, when implemented a surface of the pultrusion 105 may abut a studding material and another surface of the pultrusion 105 may abut drywall material. The protrusion 105 may abut a wall when the insert 101 is implemented within the wall, thereby preventing over insertion of the insert 101 within the wall. The protrusion 105 may be implemented at any location along the body 103 that allows the insert 101 to be secured against a wall. Grips 107 are also located on and extend from the body 103. The grips 107 prevent the insert 101 from being easily removed from a wall after the insert 101 is implemented within the wall. The grips 107 can have shapes typically associated with anchoring construction tools, which includes sharper and duller projections. In certain examples, the length of the insert 101 may be varied from greater than a ½ inch to greater than 3 inches. In other examples, the length of the insert 101 may be greater than ¾ inch to 2 inches or even an inch.

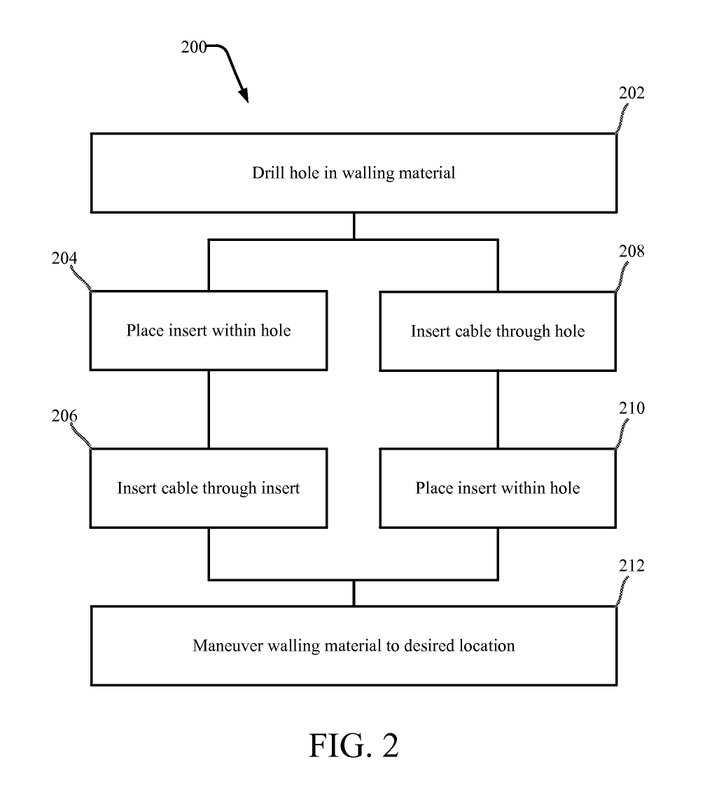

FIG. 2 illustrates a method 200 of using the inserts 100, 101 described herein. At block 202 a hole is drilled into walling material, such as drywall for example. At block 204 the insert is placed through the hole to a position where the insert is secured, i.e., the insert is not easily removed. For example, this may involve inserting one or more grips of the insert through the hole. At block 206 cable or like material desired to be placed through the walling material is inserted through the insert. Alternatively, at blocks 208 and 210 the cable or like material may be inserted through the hole and an insert, surrounding the cable or like material, is then placed within the hole. At block 212 the walling material is maneuvered to a desired location, e.g., drywall is hung. While an implementation describes the walling material being constructed after installation of the insert and cable or like material, one skilled in the art should appreciate the walling material may be constructed into a wall prior to insertion of the insert and cable or like material without departing from the scope of this disclosure.

Although the devices and methods have been described and illustrated in connection with certain implementations, many variations and modifications should be evident to those skilled in the art and may be made without departing from the spirit and scope of this disclosure. This discourse is thus not to be limited to the precise details of methodology or construction set forth above as such variations and modifications are intended to be included within the scope of this disclosure.

1. An insert, comprising:
an elongated body having a first end;
a protrusion outwardly extending from an axis of the elongated body, the protrusion is positioned away from the first end of the elongated body, and
grips outwardly extending from the axis of the elongated body proximate a second end of the elongated body
wherein the grips are along the elongated body between a second end and the protrusion, and the protrusion and the first end are separated by a distance.

2. The insert of claim I, wherein the protrusion has a circular cross-section.

3. The insert of claim 1, wherein the protrusion radially extends from the axis of the elongated body, the axis extending through a central cavity of the elongated body from the first end to the second end.

4. The insert of claim 1, wherein the grips encircle the elongated body.

5. The insert of claim 1, wherein each of the grips radially extend from the axis of the elongated body.

6. The insert of claim 1, wherein each of the grips has a 1 surface parallel to a surface of the protrusion.

7. The insert of claim 1, wherein each of the grips has a surface angularly extending inward toward the second end of the elongated body.

8. An insert, comprising; a tubular body;
a protrusion radially extending from the tubular body proximate offset from a first end of the tubular body; and
a plurality of grips radially extending from the tubular body proximate a second end of the tubular body, wherein the grips are along the elongated body between a second end of the tubular body and the protrusion.

9. The insert of claim 8, wherein the tubular body is elongate from the first end to the second end.

10. The insert of claim 8, wherein the tubular body has an axis extending between the first and second ends of the tubular body.

11. The insert of claim 8, wherein one of the grips of the plurality of grips abuts the second end of the tubular body.

12. The insert of claim 8, wherein each of the plurality of grips 1 has a surface that radially extends from the tubular body parallel to a surface of the protrusion.

13. The insert of claim 12, wherein the surface of each of the plurality of grips has a circumferential edge, the circumferential edges being distal edges of the plurality of grips with respect to the tubular body.

14. A method of using an insert, comprising the steps of:
drilling a hole within walling material; and placing an insert having a protrusion positioned away from the end of the insert and grips through the walling material until the protrusion abuts the walling material and the grips secure the insert to the walling material.

15. The method of claim 14, further comprising the step of:
placing cable through the insert.

16. The method of claim 14, further comprising the steps of:
maneuvering the walling material to a desired location; and securing the walling material.

17. The insert of claim 1, wherein the protrusion is off-centrally located along the axis of the elongated body.

18. The insert of claim 8, wherein the protrusion is off-centrally located along the axis of the tubular body.

19. The insert of claim 1, wherein there is a distance between the end of the insert and protrusion and the distance is greater than 0 and less than ¾ inch.

20. The insert of claim 1, wherein there is a distance between the end of the insert and protrusion and the distance is greater than 0 and less than ¾ inch.
